(19) United States
(12) Patent Application Publication
(10) Pub. No.: US 2010/0148623 A1
(43) Pub. Date: Jun. 17, 2010

(54) HIGH VOLTAGE MOTOR WINDINGS

(75) Inventor: Joseph Liu, Ramona, OK (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/334,579

(22) Filed: Dec. 15, 2008

(51) Int. Cl. H02K 3/34; F04B 17/03

(52) U.S. Cl. 310/215; 417/423.3; 166/372

(57) ABSTRACT

An electric submersible pump (ESP) includes a pump and an electric motor operationally connected to the pump, the electric motor includes a rotor; a stator having a plurality of stator slots; a plurality of magnet wires positioned in each stator slot; and a member positioned within the stator slot, the member maintaining the magnet wires substantially parallel to one another.

### TECHNICAL FIELD

The present application relates in general to electric motors and more specifically to high voltage motor windings and slot liners.

### BACKGROUND

The positioning of coils or wires in an electric motor may influence voltage stress between winding turns of wires. If wires in stator slots are crossed, it may create high voltage stress between winding turns and may reduce reliability.

### SUMMARY

In one embodiment an electric motor includes a stator having a plurality of stator slots and a plurality of wire windings disposed in each stator slot, wherein the plurality of wire windings are insulated from one another.

An embodiment of an electric submersible pump (ESP) includes a pump and an electric motor operationally connected to the pump, the electric motor includes a rotor; a stator having a plurality of stator slots; a plurality of magnet wires positioned in each stator slot; and a member positioned within the stator slot, the member maintaining the magnet wires substantially parallel to one another.

An embodiment of a stator liner for positioning in a stator slot of an electric motor includes a member formed of a dielectric material, the member defining a plurality of pathways oriented substantially parallel to one another, wherein the member is adapted to be positioned within the stator slot and to dispose wire windings in the pathways.

The foregoing has outlined some of the features and technical advantages of the present invention in order that the detailed description that follows may be better understood. Additional features and advantages of the invention will be described hereinafter which form the subject of the claims.

### BRIEF DESCRIPTION OF THE DRAWINGS

The foregoing and other features and aspects described in the present application will be best understood with reference to the following detailed description, when read in conjunction with the accompanying drawings, wherein:

FIG. 1 is a well schematic illustrating an electric submersible pump disposed in a wellbore;

FIG. 2 is a plan view of an electric motor along the line I-I of FIG. 1;

FIG. 3 is an expanded view of the window “A” of FIG. 2 illustrating an embodiment of a stator liner; and

FIGS. 4A-4D are exploded views of a portion of slot liners illustrating different cross-sectional views of liner pathways.

### DETAILED DESCRIPTION

Refer now to the drawings wherein depicted elements are not necessarily shown to scale and wherein like or similar elements are designated by the same reference numeral through the several views.

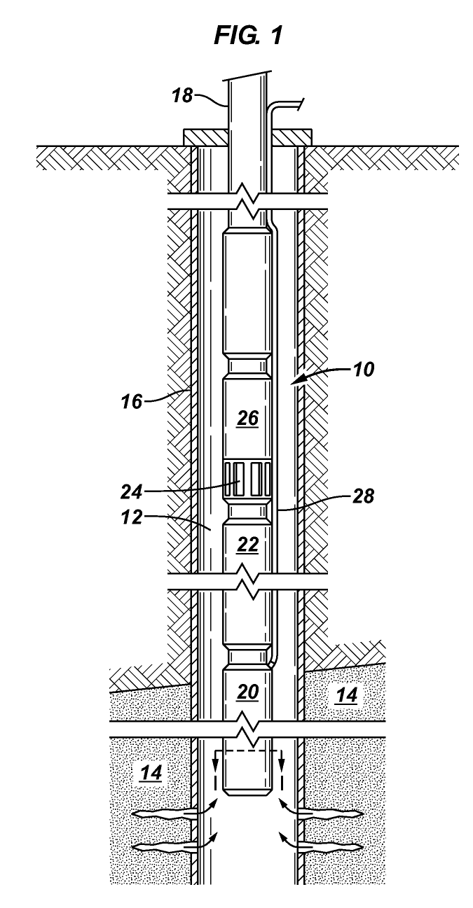

FIG. 1 is a well schematic illustrating an electric submersible pump (ESP), generally denoted by the numeral 10, disposed in a wellbore 12. Wellbore 12 extends into a geological formation 14 and may be lined with casing 16. Casing 16 may be perforated to allow fluid to flow into casing 16. ESP 10 is fluidly connected with a conduit 18 for producing fluid via ESP 10 from wellbore 12.

Electrical submersible pump 10 may include an electric motor 20, a motor protector 22, a pump intake 24, and a pump 26. A power cable 28 provides electricity to motor 20. In the described embodiment, electric motor 20 provides greater than 4200 volts and in some embodiments provides approximately 7,000 volts or more.

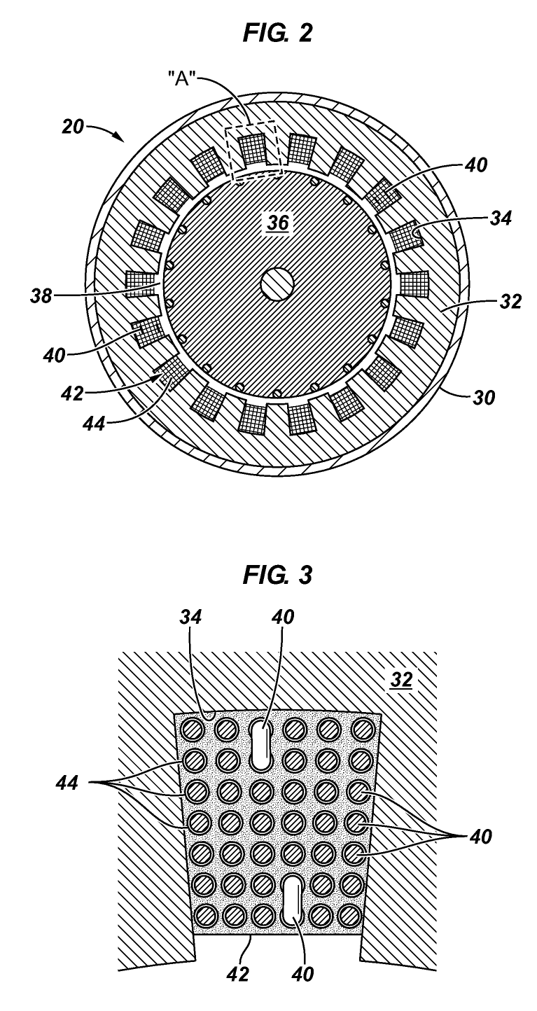

FIG. 2 is a plan view of electric motor 20 along the line I-I of FIG. 1. In the illustrated embodiment, electric motor 20 includes a housing 30, stator 32, stator slots 34, and a rotor 36. Rotor 36 is separated from stator 32 and stator slots 34 by an air gap 38. Rotor 36 may provide several rotor slots and a shaft. Wire 40 windings, also referred to from time to time as magnet wires, coils, wire and like terms, are positioned within slots 34 and induce magnetic flux through stator 32 when they are conducting an alternating electric current. In the illustrated embodiment an insulating liner 42 having a plurality of pathways 44 is disposed in stator slots 34 so as to control the positioning of wire 40 windings in each slot 34.

Refer now to FIG. 3 wherein an expanded view of window “A” of FIG. 2 is provided. Slot liner 42 is constructed of a dielectric material such as, without limitation, polyetheretherkeyone (PEEK) and fluoropolymers such as polytetrafluoroethylene and fluorinated ethylene propylene and the like.

Slot liner 42 is a honeycomb like member providing a plurality of pathways 44 for disposing windings of wire 40. Wire 40 windings are positioned in pathways 44 of stator liner 42 thereby providing electric insulation between the windings of wires 40. In the illustrated embodiment, pathways 44 extend parallel to one another thereby positioning wires 40 parallel to one another.

In one embodiment, U-shaped wires 40 are positioned in pathways 44 and the unconnected ends of the U-shaped wires are then connected on the other end of stator 32. By preventing the crossing of windings of wire, a reliable high-voltage motor may be provided.

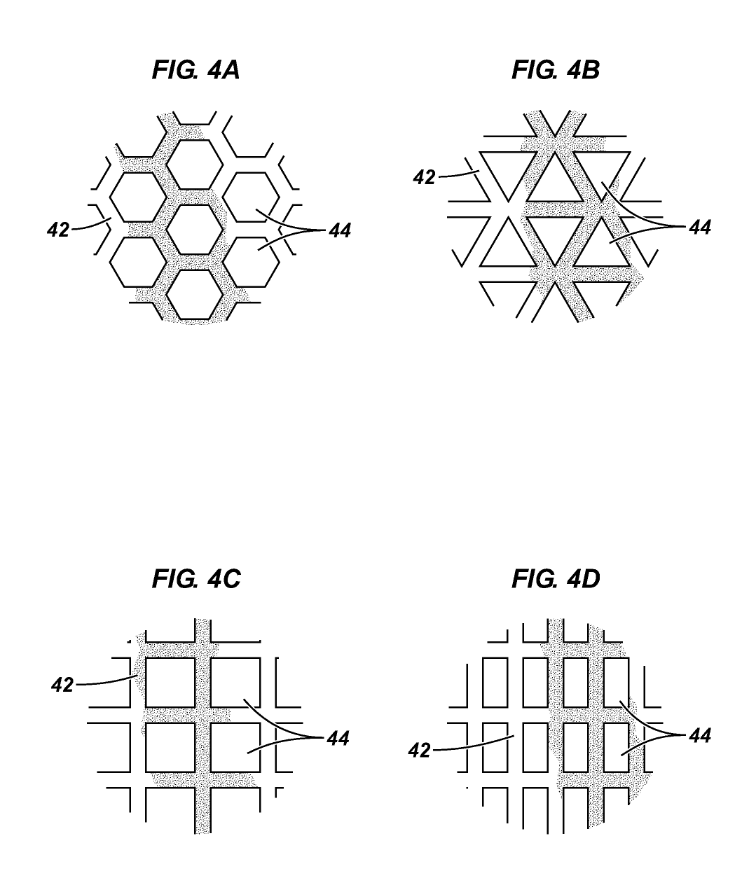

In the embodiment of FIG. 3, pathways 44 are illustrated as having circular cross-sections. However, it is understood that pathways 44 may have non-circular cross-sections. For example, pathways 44 may have cross-sectional configurations such as, and without limitation to, hexagon shaped cross-sections (FIG. 4A), triangle shaped cross-sections (FIG. 4B), square shaped cross-sections (FIG. 4C), and rectangular shaped cross-sections (FIG. 4D).

From the foregoing detailed description of specific embodiments of the invention, it should be apparent that a system for improving positioning of wires in stator slots that is novel has been disclosed. Although specific embodiments of the invention have been disclosed herein in some detail, this has been done solely for the purposes of describing various features and aspects of embodiments, and is not intended to be limiting with respect to the scope of the claims. It is contemplated that various substitutions, alterations, and/or modifications, including but not limited to those implementation variations which may have been suggested herein, may be made to the disclosed embodiments without departing from the spirit and scope of the claims which follow.

1. An electric motor comprising:
a stator having a plurality of stator slots;
a slot liner positioned in each stator slot, the slot liner constructed of a dielectric material forming a plurality of pathways therethrough; and
a plurality of wire windings, wherein each wire winding of the plurality of wire windings is disposed within one pathway of the plurality of pathways such that each wire winding of the plurality of wire windings is electrically insulated from the other adjacent wire windings of the plurality of wire windings.

2. The electric motor of claim 1, wherein the plurality of wire windings positioned in each stator are oriented parallel to one another by the plurality of pathways.

3. The electric motor of claim 1, wherein the motor has a voltage rating greater than 4,200 volts.

4. The electric motor of claim 1, wherein the motor has a voltage rating of 7,000 volts.

5. The electric motor of claim 1, wherein the motor has a voltage rating of greater than 7,000 volts.

6. The electric motor of claim 2, wherein the motor has a voltage rating greater than 4,200 volts.

7. The electric motor of claim 2, wherein the motor has a voltage rating of approximately 7,000 volts.

8.-11. (canceled)

12. An electric submersible pump (ESP), comprising:
a pump; and
an electric motor operationally connected to the pump, the electric motor comprising:
a rotor;
a stator having a plurality of stator slots;
a dielectric member positioned in each slot of the plurality of slots, wherein each dielectric member defines a plurality of pathways therethrough; and
a magnet wire positioned in each pathway of the plurality of pathways, such that each magnet wire is electrically insulated from the other magnet wires positioned in the other pathways of the plurality of pathways.

13.-14. (canceled)

15. The ESP of claim 12, wherein the electric motor has a voltage rating of approximately 4,000 volts or greater.

16. The ESP of claim 12, wherein the electric motor has a voltage rating of approximately 7,000 volts or greater.

17. (canceled)

18. A stator liner for positioning in a stator slot of an electric motor, the stator liner comprising a member formed of a dielectric material, the member defining a plurality of pathways , wherein the dielectric member is adapted to be positioned within the stator slot and to dispose a wire winding in the each pathway of the plurality of pathways after the stator liner is disposed in the stator slot so that each of the wire windings is electrically insulated from the other wire windings.

19. The stator liner of claim 18, wherein the plurality of pathways are oriented substantially parallel to one another.

20. The ESP of claim 12, wherein the plurality of pathways are oriented substantially parallel to one another.
